(19) United States
(12) Patent Application Publication
(10) Pub. No.: US 2010/0031314 A1
(43) Pub. Date: Feb. 4, 2010

(54) DISTRIBUTED PICO-CELL MOBILITY

(75) Inventors: Gunnar Rydnell, Frolunda (SE); Jan Lindskog, Pixbo (SE); Roger Walther, Molndal (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/722,375

(22) PCT Filed: Jan. 14, 2005
(86) PCT No.: PCT/IB05/50171

§ 371 Date: Jun. 21, 2007

(30) Foreign Application Priority Data
Dec. 22, 2004 (IB) PCT/IB2004/052903

(51) Int. Cl. H04L 9/32; H04W 36/00

(52) U.S. Cl. 726/3; 370/331

(57) ABSTRACT

System (PAA-BSS) comprising a plurality of access points (AP), defining a pre authentication area (PAA), the system communicating a list of frequencies relating to the access points of the pre-authentication area (PAA) and information as to the relative position of the access points to the a mobile station seeking pre-authentication before the system. Method of preparing a mobile station for handover between access points, wherein the mobile station associating (11, 21, 31) with a first access point in a predetermined group of access points (PAA-BSS) defining a pre-authentication area (PAA), the mobile station authenticating (12, 22, 32) itself before at least one prevalent access point of the group (PAA-BSS), upon being accepted for authentication before the prevalent, the mobile station receiving a response comprising a list of frequencies (14, 24, 34) pertaining to access points of the group (PAA-BSS).

### FIELD OF THE INVENTION

This invention pertains to the area of wireless radio access techniques for pico-cell systems. More particular, the invention concerns the area of mobility enhancements for the IEEE 802.11 MAC layer and systems and methods making use of the latter.

### BACKGROUND OF THE INVENTION

The current standard for WLAN IEEE 802.11 has recently gained success in being wide spread to customers with the purpose of replacing wired Ethernet LANs with wireless access. The current deployed standard 802.11b, is using the 2.4 GHZ unlicensed band. At the time of writing the application, it is forecasted that if the current rate of deployment continues, the spectrum in the 2.4 GHz band will soon be insufficient, and that a migration to 5 GHz and 802.11a will take place. The 802.11a specification uses OFDM signalling at the PHY layer and the use of higher PHY rates. The IEEE 802.11 MAC layer and the MAC management are common to all PHY layers specified in 802.11.

The IEEE 802.16 Study Group on Mobile Broadband Wireless Access (MBWA) addresses radio access for fast moving vehicles with speeds up to above 200 km/h. It has been found advantageous to leverage the success of deployment of IEEE 802.11 WLANs when specifying a new protocol for Mobile Access in IEEE 802.16. However, the typical range for IEEE 802.11 systems is restricted to 100 m, whereby a fast moving vehicle will travel through a number of cells in very short time.

The 802.11 mobility protocol is not adapted for deployment as a cellular system with high mobility. The 802.11 system has a flat and distributed architecture. The access points are all connected to each other and may be able to communicate to each other using proprietary protocols on the LAN level. In 802.11 systems, handover (HO) between access points are initiated by the mobile station, but only when the mobile station detects that a new access point is present by reading its beacon.

In GSM, arrangements are known in which pico-cells are distributed within the range of macro-cells, also denoted umbrella cells. Radio network parameters are set such that fast moving mobile stations will be pushed up to the large umbrella cells and will not dwell in the pico-cells, thereby avoiding excessive numbers of handovers.

Prior art document WO98/35511 shows a radio telephone system installed along a railway, whereby a mobile telephone on the train is handed over from base station to base station along the track. The setting up of a call on one channel between a mobile telephone and a base station causes the system to reserve the same channel at the next base station, thereby preparing for the call handover procedure to be effected.

According to the 802.11 MAC management pre-authentication is provided. The pre-authentication option allows a mobile station to be associated and authenticated before a given access point and allows subsequently the mobile station to be pre-authenticated before other given access points while being associated with the first access point so as to facilitate a smoother expected handover. According to the “802.112 Handboook”, by B. O'hara and A. Petrick, IEEE press, 1999, one may chose to propagate a mobile station's authentication from one access point to another through the distribution system, DS, obviating the need for more than a single, initial authentication.

### SUMMARY OF THE INVENTION

A mechanism is needed for more efficient mobility of fast moving mobile stations in pico-cell radio networks, in particular to the situation of MBWA deployment in road and railroad applications.

It is a first object of the invention to set forth a method and a system for increased handover speed between predefined cells.

This method has been accomplished by the subject matter set forth in method claim 1, system claim 5 and node claim 10.

It is a secondary object to set forth increased handover speed between a contiguous distribution of cells.

According to one aspect of the invention, extensions to the IEEE802.11 mobility protocol to be used for MBWA radio access has been set forth. However, the ideas presented here are generally applicable to any pico-cell radio network, and maybe even more suited to a HiperLAN2 WLAN, given that the PHY layer is modified to a MBWA-PHY as proposed elsewhere.

Further advantages will appear from the following detailed description of the invention.

### BRIEF DESCRIPTION OF THE DRAWINGS

FIG. 1 shows a first embodiment of the system according to the invention,

FIG. 2 shows a second embodiment of the system according to the invention,

FIG. 3 discloses a timing diagram according to the first embodiment of the invention;

FIG. 4 discloses a timing diagram according to the second embodiment of the invention,

FIG. 5 discloses an alternative timing diagram according to the second embodiment of the invention, and

FIG. 6 shows an exemplary way of arranging access points along a route of transportation.

### DESCRIPTION OF PREFERRED EMBODIMENTS OF THE INVENTION

According to a preferred embodiment of the invention, a pico-cell deployment along a highway or a railroad based on the IEEE 802.16 MBWA and using 802.11-like access points, APs, is considered. For such an application, each access point would typically be installed on the side of the highway covering a range of 100 m, thus there would be access points every 100 m in order to cover a part of the highway. A vehicle moving along the highway communicates with the closest access point. When moving into the next access points coverage area (pico-cell), the mobile station must first determine that a cell change has occurred, find the frequency of the new access point and re-associate with the new access point. The access point discovery and re-association mechanism specified in 802.11 will take some time, as it is not optimised for fast handover. In fact, 802.11 PHY is not meant for usage by fast moving stations (as opposed to MBWA).

For mobile stations moving along a highway or a railroad of the above application, there will in many cases only be “one way to go”. In other words, there is a certain expectancy that the station will hand over to a given “next coming” access point. According to the invention, it is not necessary to demand that the mobile station initiates the HO. The fixed network side can initiate and prepare HO to a group of cells further along the travelling path. In this way, a group of access points can pre-authenticate the mobile station in advance by signalling between each other without communicating with the mobile station itself.

In this context, a pre-authentication area, PAA, is a linear or other contiguous structure consisting of a number of access points that the mobile station will visit in a known sequence. In the more general case, a pre-authentication area can consist of any network of access points without any specific geographical relation. Other interesting cases may be that a pre-authentication area consists of all access points in a sub-net, in a building, in a company or whatever. However, these cases may not be so interesting for HO optimisation, since moving around inside a building is seldom done at high speed.

### First Embodiment of the Invention

In FIG. 1, a first embodiment of a network has been shown. The network comprises a number of access points AP3, AP4, AP5 . . . AP6 connected with one another over a distribution system, DS, which provides Internet access. The above access points form a pre-authentication area, PAA, according to the invention and the access points may advantageously define a partly overlapping contiguous coverage, which may be arranged so as to follow a road or railway. Access points, AP10, which are not part of the PAA area may also be provided and connected to the distribution system. A system node, MSYS, may also be provided according to the invention, for authentication purposes.

According to the first embodiment of the invention, the pre-authentication area, PAA, comprises a set of non-hierarchical access points as shown in FIG. 1 but without the MSYS node. Each access point constitutes the gateway towards the Internet. The access points are moreover connected with one another by means of the distribution system also denoted backbone network.

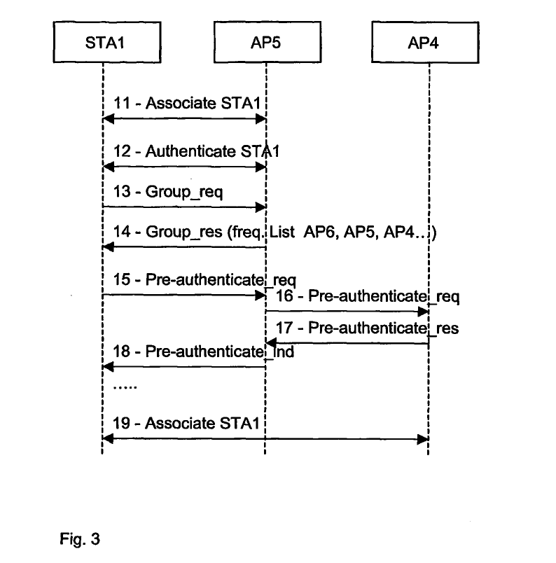

In FIG. 3, a timing diagram pertaining to the first embodiment of the invention has been shown. It should be understood that exemplary access points AP5 and AP4 are part of a pre-authentication area, which may comprise many more access points (not shown).

The station STA1 moves into the pre-authentication area, PAA, and seeks to perform legacy steps of associating, 11, and authenticating, 12, before the access point AP5 that is encountered. The authentication with the access point may be based on the known Wired Equivalency Privacy, (WEP) authentication scheme or on alternatives offering a higher degree of security.

In step 13, the station STA1 issues a Group_Req message, 13, indicating to the access point that the mobile station is capable and interested in performing pre-authentication, PA, according to the invention. The issuance of the Group_req message may be conditional to inputs from higher layer software, for instance in dependency of whether the station is moving or can be expected to move above a predetermined speed.

In response, in step 14, the station receives a Group_res message including a list of frequencies pertaining to the access points in the pre-authentication area PAA. If the pre-authentication area, PAA, constitutes a linear distribution of cells, the list of frequencies are preferably arranged in the order corresponding to the geographical index position in the group. In this manner the station can restrict its expected search for the frequencies of the two neighbouring order numbers, in this case AP6 and AP4. Note that the station cannot necessarily expect to obtain initial contact with one of the outer access point in the pre-authentication area, PAA. This is the case if the station moves too fast or if the traffic situation for the access point is congested. Moreover, once the travelling direction is established, the station only needs to scan after one frequency. Directional antennas can also be arranged so that a first PAA group points in one direction and a second PAA group points in the other direction.

In step 15, a pre-authentication request is issued from the station to the access point with which it has been associated. The pre-authentication request is echoed, step 16, from this access point to all other access points in the pre-authentication area, PAA. Subsequently, in step 17 pre-authentication responses are received from all involved access point's, via the associated access point. It is noted that all inter access point traffic is delivered over the backbone in normal BSS fashion.

When the station has moved into reach of the next access point—in this case AP4—the station can now immediately scan for the frequency used by AP4 and perform association without subsequent authentication, because the station is pre-authenticated.

### Second Embodiment of the Invention

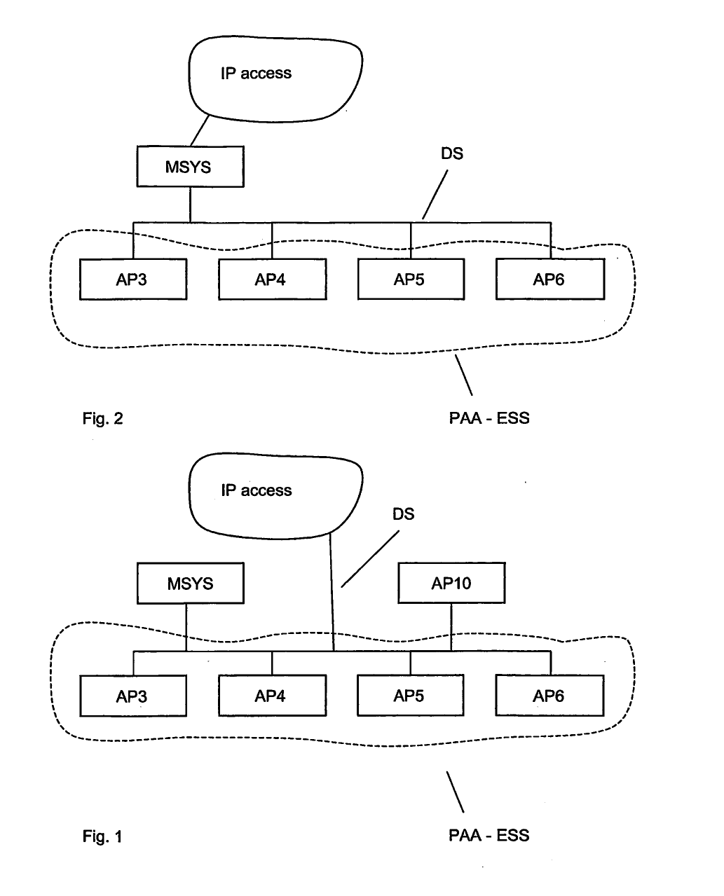

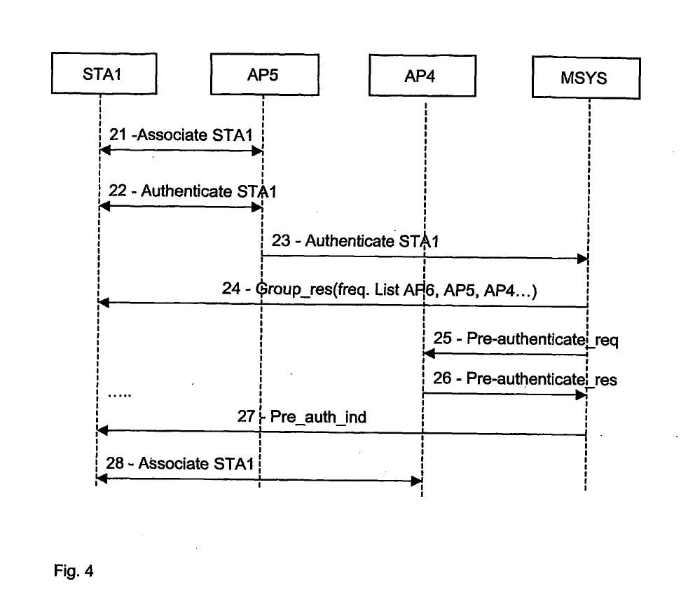

In the second embodiment of the invention, the PA structure is hierarchical in the sense that a system node, MSYS, coupling the BSS constituted by the AP's in a pre-authentication area, provides access to the Internet. In FIG. 2, a second embodiment of the network according to the invention is provided. The network differs from the network shown in FIG. 1, in that the system node is a gateway to the Internet access network. FIG. 4 shows a timing diagram pertaining to the second embodiment of the invention.

In this embodiment the MSYS has the role of performing the exclusive authentication of stations entering the pre-authentication area or providing additional authentication of stations. If the authentication is approved for a given station, access is given to that station.

In step 21, respectively step 22, the legacy step of association towards a first encountered access point—in this case AP5—is accomplished. Step 22—the station authenticating itself before the access point is optional.

Subsequently, in step 23, the associated access point, AP5, is seeking to authenticate the Station, STA1, before the gateway node, MSYS.

If the authentication is successful, the station is allowed access to the Internet. Moreover, MSYS responds with a Group-response signal to the station—step 23—indicating that it is in the process of pre-authenticating the station before the remaining access point's in the pre-authentication area. The Group response signal, step 24, includes a list of frequencies of all members of the pre-authentication area as explained above and having the same effects as explained above.

Following, in steps 25 and 26 the gateway node issues a pre-authentication request to the remaining access points in the pre-authentication area, PAA. Those access point's that accept respond with an optional pre-authentication response signal, 26.

Based on this result, the MSYS may optionally inform the station, for which access point's the station has been pre-authenticated, by means of a pre-authentication indication signal, 26. The station may thereby modify its efforts to seek for handover candidates, that is, omit seeking for frequencies of access point's by which the station has not been pre-authenticated.

When the station has moved on to the next access point, in this example, AP4, the station is ready for a swift handover only requiring the process step of association, step 28.

### Third Embodiment of the Invention

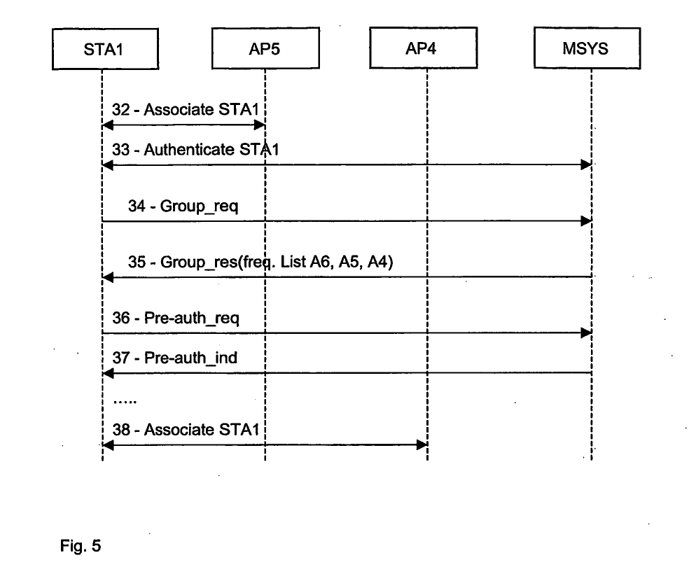

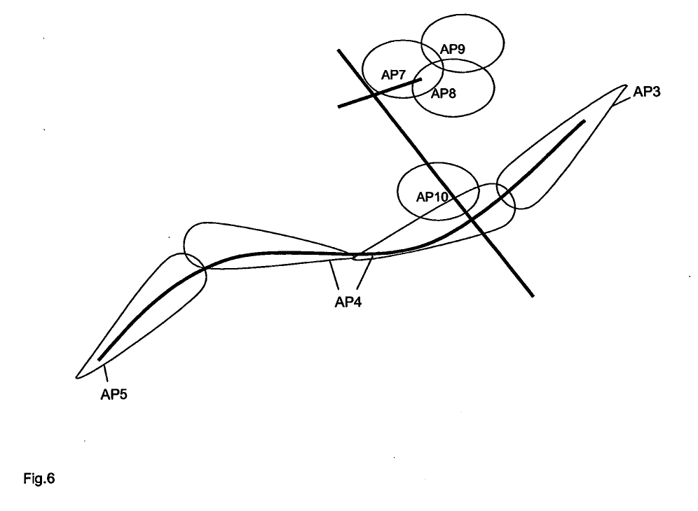

This embodiment, like the above embodiment, comprises a gateway node controlling access to the Internet, as shown in FIG. 2. FIG. 5 shows a timing diagram of the third embodiment of the invention.

In this embodiment, there is no authentication before the access points of the pre-authentication area, PAA.

After the association in step 32, the station authenticates, step 33, with the gateway node, MSYS. Messages are communicated over the distribution system between the associated access point and the gateway node.

The station then issues a group request message, 34, signalling to the gateway node that is interested in being pre-authenticated for other access point's in the pre-authentication area, PAA. The station may refrain from issuing the request if this is determined by upper layer programs, for instance as a result of the station being stationary or moving in an local area including other access point's, which are not part of the pre-authentication area.

The gateway responds with a group response message, 35, including the list of frequencies for the purpose as explained above.

Subsequently, the station initiates pre-authentication requests to the MSYS for pre-authentication in the remaining access points in the pre-authentication area, PAA, in the order according to the choice of the station.

When the station moves within reach of the next AP—AP4—association can be undertaken and traffic can immediately be transferred to the gateway node.

### Further Embodiments

For all the embodiments above it is preferable that the outer access point's is arranged such that their antenna characteristics match the typical traffic pattern and allows fast moving stations enough time to perform the initial steps of associating and authenticating. For instance, an outer index access point could have a narrow beam antenna pointing along a linear stretch, such as corresponding to a highway thereby offering long-range contact. Antennas providing directional capabilities are widely known in the art.

The signalling method between the access points in setting up the PA-area can be any proprietary protocol or a standardised IAPP, such as the IAPP as specified by IEEE 802.11f.

According to a further embodiment of the invention, the access points are time-synchronised, such that the station can expect signalling from an expected next coming access point to appear at a certain time. In this case, HiperLAN2 may be even more suited due to faster response and more accurate timing of beacons (BCCHs).

In HIPERLAN/2 and IEEE 802.11a the RF carrier and the symbol clock frequency are derived from the same reference oscillator. The requirement for the oscillator accuracy is ±20 ppm. This means that even if the beacon interval is fixed for the access points (AP), the timing offset between the beacon transmissions between two access points (AP) can change 40 μs, 10 OFDM symbols, in 1 second. In order to maintain a fixed offset between the beacon transmissions, some kind of access point synchronisation is required.

The synchronisation can be achieved in many ways. According to the invention, a reference clock may be transmitted to all access points, wired or wireless, from the system node or from a dedicated access point in the pre-authentication area, PAA. Another way is that the access points can listen to each other and estimate the frequency offset to the adjacent access points.

The beacon interval can then be adjusted to a common interval, i.e. the number of samples between beacons is not fixed but the time is fixed. It may also be possible to adjust the access point reference oscillator. Then the number of samples between beacons is fixed as well. If the reference oscillator for all access points are synchronised, the channel spacing will be exactly 20 MHz and there is no frequency offset between access points. Hence, the stations will experience exactly the same frequency offset versus all access points, i.e. all channels. This knowledge can be used to improve the receiver performance of the mobile stations.

According to the invention, the central node in a pre-authentication area, PAA, can also control the beacon offset between the access points. This can reduce the overhead for relaying information on the beacon offset to the mobile stations. E.g. if a mobile station is travelling along a road it knows that the next access point will have a defined beacon offset compared to the current access point. I.e. the next access point will always have a beacon offset of +x μs, or −x μs if the mobile station is travelling in the opposite direction. Hence, less information on the beacon interval and offsets for a pre-authentication area, PAA, has to be transmitted to the mobile stations.

1. A method of preparing a mobile station for handover between access points, the method comprising the steps of
the mobile station associating with a first access point in a predetermined group of access points defining a pre-authentication area (PAA),
the mobile station authenticating itself before at least one prevalent access point of the group,
upon being accepted for authentication before the prevalent, the mobile station receiving a response comprising a list of frequencies pertaining to access points of the group.

2. The method according to claim 2, wherein the list of frequencies comprise information as to the relative index position of the access points of the pre-authentication area relative to one another.

3. The method according to claim 1, wherein the mobile station is transmitting a group request to a given access point of the pre-authentication area subsequent to the mobile station being authenticated before a given access point.

4. The method according to claim 1, wherein, a pre-authentication indication is transmitted to the mobile station upon being authenticated before a given access point in the pre-authentication area.

5. A system comprising a plurality of access points, defining a pre-authentication area, the system communicating a list of frequencies relating to the access points of the pre-authentication area and information as to the relative position of the access points to the a mobile station seeking pre-authentication before the system.

6. The system according to claim 5, wherein the access points (AP) of the system are being arranged along a line or curve offering coverage substantially along a main route of transportation.

7. The system according to claim 5, wherein the access points are synchronised so as to issue beacon signals at a predefined beacon interval according to a commonly defined period.

8. The system according to claim 5, wherein, the access points in the PAA are arranged in a contiguous fashion, preferable along a line or curve, such that, outer access points are defined, the outer access points having index access points arranged between them along the line or curve.

9. The system according to claim 5, wherein a given access points at least have one directional antenna directed towards an adjacent access point

10. The system according to claim 5, wherein the system comprises a system node performing authentication of mobile stations entering the pre-authentication area

11. A mobile station being adapted for associating and authenticating itself before an access point, the mobile station, upon receiving a response signal, comprising a list of frequencies relating to a group of access points of a pre-authentication area, for pre-authenticating the mobile station to said group.

12. The mobile station according to claim 11, wherein the response signal, comprises information as to a preferred relative index position of the access points of the pre-authentication area for resolving neighbouring access points to the access point with which the mobile station is currently associated from the response signal and restricting search for handover candidates to said neighbouring access points.
